(19) United States
(12) Patent Application Publication
(10) Pub. No.: US 2013/0157346 A1
(43) Pub. Date: Jun. 20, 2013

(54) COMPUTER CONTROLLED IN-VESSEL COMPOSTING PROCESS AND APPARATUS

(71) Applicant: Paul E. Kerouac, Palm Coast, FL (US)

(72) Inventor: Paul E. Kerouac, Palm Coast, FL (US)

(21) Appl. No.: 13/716,252

(22) Filed: Dec. 17, 2012

Related U.S. Application Data
(60) Provisional application No. 61/576,626, filed on Dec. 16, 2011.

(51) Int. Cl. C05F 17/02

(52) U.S. Cl. CPC C05F 17/0223
USPC 435/267; 435/290.3

(57) ABSTRACT

An in-vessel composting apparatus and process for continuous processing of food waste into an end product comprising a bulk organic compost material. The apparatus comprising a shredder/particle sizer feeding a horizontal drum having at least three chambers with connecting ports of sequentially increasing diameter, and through to a bulk collection container. The apparatus is further equipped with motorized drum rotation and provision for compressing and draining excess fluid from the incoming feed stock and then reintroducing it in the third chamber as needed to maintain suitable moisture level.

### RELATED APPLICATIONS

This application claims the benefit of U.S. Provisional Application No. 61/576,626, filed Dec. 16, 2011, which is herein incorporated by reference in its entirety for all purposes.

### FIELD OF THE INVENTION

The invention relates to reduction and contained decomposition of organic waste material, and more particularly, to a unitized process and apparatus for reducing and in-vessel composting raw food waste and biodegradable eating utensils and trays, yard waste, and newspapers, in combination with associated organic packing materials such as cardboard and paperboard containers, into a useful compost product.

### BACKGROUND OF THE INVENTION

According to published sources, in all, the United States generates approximately 208 million tons of municipal solid waste per year. Public and private sectors, alike, are facing increasing cost and difficulty in disposing of their enormous and increasing tonnage of solid waste and garbage in an environmentally sound and economically acceptable manner. Historically, refuse or garbage has been collected and disposed of by one of several inexpensive means, such as open burning, dumping in waterways, or dumping in common landfills.

As the ecological impact of such practices became evident, the demand for safer practices grew. Three methods emerged as environmentally suitable means for safe refuse disposal: (1) sophisticated landfills with costly structures and controls designed to prevent leaching into surrounding ground water; (2) controlled incineration; and (3) composting in which the compost product has a reduced toxicity suitable for subsequent disposal in a landfill. However, according to data from the United States Environmental Protection Agency, the number of operating landfills in the U.S. has dropped by more than half in the past ten years.

Although municipal incinerators are more environmentally friendly than they were a generation ago, they continue to release gases and solid particles that may harm human health, damage property, and kill plants. The biggest components of all municipal solid waste are compostable; yard waste, corrugated boxes, and food waste.

The benefits of composting have long been known. Though not a fertilizer, it is a useful soil conditioner that improves texture, air circulation, and drainage. Compost moderates soil temperature, enhances nutrient and water-holding capacity, decreases erosion, inhibits weed growth, and suppresses some plant pathogens. High quality compost is being used for and marketed as a soil amendment and as mulch for landscaping, farming, horticulture, and home gardens. Compost can also be used as landfill cover or in land reclamation projects.

There is a large body of art relating to in-vessel composting, some providing useful descriptions of the basic biological process. Existing in-vessel composters typically have one or more of the following general short-comings. (1) the system is too complex and the cost to purchase and operate is cost prohibitive to small businesses and organizations, (2) the system requires an extended processing time of generally greater than three weeks, such that the necessary capacity of the system becomes cumbersome and/or restrictive, or (3) the process produces output material which is less than 60% composted when removed from the vessel, requiring additional composting and processing time prior to curing.

There remains a need for an affordable, simple to operate, energy efficient, in-vessel composting system that substantially reduces the volume and weight of the input materials, and processes a useful end product of commercial value.

### SUMMARY OF THE INVENTION

Disease-suppressive compost is not made by accident. It comes about by carefully monitoring the atmosphere inside of a composting vessel to ensure that the temperature, moisture, and oxygen levels are all maintained at proper levels throughout the entire process. Varying species of bacteria present in the composting vessel will break down and organic materials into the output compost mixture. And, as temperatures rise and fall in the compost, different bacterial species will become more or less active. Psychrophilic bacteria, mesophilic bacteria and thermophilic bacteria each operate best within specific temperature ranges. Furthermore, with sufficient oxygen, microorganisms produce energy, grow quickly, consume more material and make nutrients available for plant growth. Without oxygen, aerobic bacteria die off and anaerobic bacteria take over. They will break down the material, but more slowly, and with an accompanying unpleasant odor. Offensive odors are produced only when the material in the system is allowed to become anaerobic, not a normal condition in the practice of this invention.

To provide a simple, reliable, efficient, in-vessel composting system, it is most useful to optimize the apparatus to a selected, well-defined waste stream, thus reducing the processing variables and simplifying the apparatus and operation. This technique offers the user a composting process and apparatus that produces a more consistent, higher quality, nutrient rich, end product.

The invention, in its simplest form, is an integrated or unitized reduction and composting process and system for the recycling of food waste and associated organic waste materials such as cardboard and paper board packaging materials, into a nutrient-rich bulk organic end product that is manageable, useful, and inoffensive. This waste stream provides an abundance of nitrogen and moisture, both important in the process. The amount of carbon and moisture absorbing bulk input can be varied, based on process conditions, by adding supplemental organic materials such as cardboard and paper board. The invention will accept traditional bulking agents such as sawdust and wood chips if desired, but is specifically designed to shred corrugated cardboard, found in many waste streams such as that of restaurants and supermarkets, to optimum size for the composting process of the invention.

The system is tolerant of a limited amount of incompatible solid contaminants that may be present in particular applications or installations. The invention utilizes a continuous four-step process which has approximately a three week throughput cycle, comprised of shredding to the optimal particle size, then mixing and composting the bulk materials through a three step, in-vessel process, while removing the excess liquid prior to the first stage. The apparatus is self-contained to provide for continuous input of raw waste, generating a bulk output of nutrient-rich compost materials of significantly less total volume and weight than the input materials.

Particle size is an important aspect of the composting process. If the waste particles are too large, the relatively small ratio of surface area to mass inhibits the start of the process. Shredding the material at the point of input offers a large advantage in this respect. On the other hand, if the input material is shred too small, porosity and the ability of the material to be aerated is greatly diminished. As a result, bacteria are less able to act. For the waste stream to which this invention is directed, an optimal particle size has been determined to be about 3/32 to 3/16 inches in diameter. A shredder in the in-feed stage provides for this requirement.

After the shredder sizes the input material, the material is directed into the first chamber of a three-chambered rotating drum. While three different drums would offer some flexibility in the control of the process, one drum and drum drive provides efficiency in the design that is reflected in cost and simplicity. The apparatus is arranged on a base frame with the drum oriented horizontal, again contributing to simplicity.

Periodic and temperature-based drum rotation, in conjunction with the periodic operation of an exhaust fan for air exchange, provides necessary cooling control within the drum. Oxygen, present in the specified waste stream materials and moisture content, and in the makeup air supplied by the exhaust fan, is present at adequate levels to sustain the composting process. Aeration for drying, cooling, and supplying oxygen is accomplished by the incremental rotations of the drum throughout the process.

Chamber to chamber progression is intentionally restricted to gradual, full diameter tumbling of the materials in each chamber, with a continual incremental spill over through a slightly larger diameter annular, axial port into the next chamber. The continuous spill over into the next chamber permits the remaining material to maintain a small but consistent forward progression through the drum as it tumbles, without inconsistent acceleration of portions of the material by intentionally angled blades, buckets or augers. This assures that the process progresses at a consistent rate in each chamber, and that the end product will be a homogenous, fully composted end product. A substantial residual volume of material is retained in all chambers at all times, further forward movement through the system and discharge of end product being dependent on regular, continuing input at the in-feeding end.

Once inside the first chamber, the material will reside there for approximately 2 to 5 days as it is slowly churned into a homogeneous mixture, any excess liquid may be drained out through ports, with each new batch of input material being quickly engulfed in the on-going composting process. A small mixing vane or like feature promotes tumbling, but does not contribute directly to forward movement through the system. Heat is readily generated by the active thermophilic bacteria, supplied with nitrogen and carbon, both inherently present in the mixture. The material is advanced to the next chamber as described above.

The center or second chamber is the main composting furnace. Having been pre-conditioned in the first chamber, the new material is quickly fully absorbed in the process. The temperature within this second chamber is maintained within the range of 150 to 169 degrees Fahrenheit, and preferably higher than 158 degrees Fahrenheit for at least 72 hours to ensure pathogen destruction if the waste food mix includes meats and dairy products. It is also necessary to maintain this temperature range to kill any seeds present within the waste stream. In contrast, from practice it was found that waste stream materials other than those containing pathogens, such as fruits, vegetables, paper, etc. will degrade to compost at temperatures as low as 95 degrees Fahrenheit due to the activity of mesophilic bacteria.

However, it should be noted that while there are no pathogenic materials to contend with, seeds within the waste stream will not be killed at such a low temperature. Just as important, the temperature of the mixture material should be kept below 170 degrees Fahrenheit as the beneficial anaerobic bacteria will begin to die off as temperatures rise above this level.

The volume of the second chamber is such that during continuous use and operation of the system, the bulk of the mixture is retained for approximately 4 to 10 days while the composting action reduces the volume of the output mixture by typically as much as 85 to 90 percent. As a result of this decrease in volume, the density of the material is increased.

A mixing vane or similar limited internal structure, as in the first chamber, promotes tumbling only. A small amount of mixture is being regularly passed into the third chamber, again by the incremental rotation and gradual flow through the next larger port. A substantial amount of residual material remains working in the second section at all times.

By the time the material reaches the third chamber, its volume has been greatly reduced due to the composting process. Due to the reduction of the material within the first two chambers, material flows into the third chamber at a much slower rate. The material, therefore, is not as quickly displaced from the third chamber. As a result, material resides in the third chamber for a longer duration, allowing the material to finalize the composting process and begin to cure. This chamber is equipped with a greater number of vanes or equivalent structures to increase tumbling and to reduce and break up any clumps in the compost material received from the second chamber.

In practice, even with less than ideal peak temperatures through the first and second chambers, seedling vegetation growth has been witnessed in the third chamber material. This is noteworthy because vegetation is unable to grow in active, unfinished compost material. This demonstrates that resultant material in the third chamber has completed the composting process and is partially cured prior to exiting through the third chamber's output port.

Meanwhile, the excess liquid which had been squeezed out or drained off may be batched and held at the same elevated temperature as the middle chamber, for three days or more, or in accordance with regulatory requirements, then percolated through the third chamber to maintain suitable moisture levels.

It has been determined that excessive liquid in the food waste materials hinders the biological activity of the composting process in the drum. An additional purpose of the invention, therefore, is to remove excess liquid from the food waste entering the drum so the second chamber in particular does not have excess liquid which will hinder the biological activity of the bulk matter composting process.

The invention described above includes means for extracting excess liquid from the in-feed material, and later percolating it through the final stage compost product in the third chamber of the drum to maintain suitable moisture levels.

As a result of the lower moisture content of the food waste during its processing in the drum, the final compost product is greatly reduced in volume, and is of generally better and more consistent quality and more easily handled than otherwise.

It is an object of the invention to provide an apparatus for the efficient, in-vessel composting of food waste and associated organic waste such as cardboard and paperboard packaging materials.

It is another object of the invention to create, essentially from food waste, a useful compost product.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a side elevation of an embodiment of the invention, showing the front end and hopper, the system enclosure, and the recovered materials compost container at the back end.

FIG. 2 is a diagrammatic side elevation of the embodiment of FIG. 1, showing the hopper, shredder, feed auger, three chamber drum with support and drive mechanism, all mounted on a base frame.

FIG. 3 is a block diagram illustrating the principal elements and the process flow of an embodiment of the invention.

FIG. 4 is a side elevation cross section of the three chamber drum of an embodiment of the invention.

FIG. 5 is a partial perspective view of the shredder of an embodiment of the invention, with its shaft-mounted rotating cutter blades.

FIG. 6 is a partial cut-away top view of the shredder and auger sections, showing part of the rotating cutter blades and interspersed teeth of the stationary striking plate, and beneath it the vanes of the auger.

FIG. 7 is a diagrammatic side elevation of another embodiment of the invention.

FIG. 8 is a diagrammatic side elevation of another embodiment of the invention illustrating the drive mechanism.

FIG. 9 is a diagrammatic side elevation of another embodiment of the invention illustrating the construction of the separate chambers.

### DETAILED DESCRIPTION

The invention is susceptible to many variations, including scaling for capacity, in so long as process parameters and control logic are maintained. Accordingly, the drawings and following description of various embodiments are to be regarded as illustrative in nature, and not as restrictive.

Process constraints include particle size, relatively significant retention quantities and dwell time in each chamber, sufficient air changes and aeration, and temperature control. Apparatus variables to be considered are the incremental amount and frequency of drum rotations required to control the heat, in combination with size and ratio of chamber length to drum diameter, and the port sizes. The preferred embodiment is intended to handle an input volume waste stream of up to one ton per day, or about seven tons per week.

The components of one embodiment of the apparatus comprise an in-feed section, a multi-chambered drum, a closed compost container, a liquid handling system, and a process control system. The in-feed section, drum, liquid handling system, and process control system are mounted on a base frame and suitably enclosed and insulated to operate as a unitary composting system. The closed compost container is mated to the back of the drum to receive and collect the bulk compost product outflow, but is free standing so as to be convenient for periodic emptying or exchange when full. The enclosure is substantially closed to drafts, but is not pressure proof, natural outgassing occurring by design in the area of the back end and compost container, and forced ventilation drawing fresh air in through the same vents.

The in-feed section has a feed hopper and lid, a material shredder/particle sizer powered by an electric motor, and an in-feed auger likewise powered by an electric motor. The drum section comprised of a large, horizontally oriented, three chamber drum, mounted on the base frame so as to be rotatable by a motorized drum drive system. The chambers are divided by substantially planar partitions, perpendicular to the axis of the drum. The drum has a relatively small axial port at the front end, and successively slightly larger axial openings or ports in the interior partitions and in the back end wall.

The raw materials path is into the hopper, through the shredder/particle sizer, through the auger into the first chamber where any remaining excess liquid may gradually be drained off, then successively through the second chamber for the majority of its composting activity, the third chamber for recombination with previously drained liquid if needed, and into the compost container.

The drum is horizontally mounted on the base frame. The graduated sizes of the axial ports provides for a retained volume of working materials in each section, and a gradual spillover of excess amounts into the next successive chamber and then into the compost container. In operation, as the drum is rotated in successive, incremental amounts, the material tumbles around the inside diameter of each chamber several times and gradually advances to the next port.

The process control system includes an operator's station, process controller and process sensors including a temperature sensor and an optional oxygen or carbon dioxide level sensor. The controller also receives inputs from the operator switch and various safety switches on the drum operation and various liquid level and temperature sensors. The controller output controls the shredder motor, the auger motor, the drum drive system, the compressor and pumps of the liquid system, and an exhaust fan air changing system equipped with a biofilter to assure non-odorous emissions. The exhaust fan duct is connected at the front end of the system so as to exhaust interior air and draw makeup air in from the back end.

An optional oxygen or carbon dioxide sensor is located in the airflow path to the exhaust fan. The temperature sensor is located at the base of the drum in the area of the center chamber. The temperature sensor assembly alternately bears on the exterior wall of the center chamber of the drum when it is not rotating, and is lifted clear by a cam linked to the drum drive system when the drum is rotating. The sensor or sensors are located at point rotationally forward of bottom dead center where the general center of mass of contained material is concentrated by the rotating action of the drum. At this location, the sensor assembly provides an indication of the temperature of the material at the height of its exothermic process, when the drum is stationary, and measures the ambient air temperature when the drum is in motion.

The operator's station is provided with a temperature readout and/or high and low temperature indicators, and with oxygen or carbon dioxide level readouts if either sensor is installed.

To conduct a periodic loading of materials into the apparatus, assumed to be as often as daily or several times a week, the operator opens the hopper, which automatically starts the exhaust fan to prevent outflow of fumes through the hopper, loads it with waste material, and closes the lid. The operating switch is then engaged to start the shredder and auger and a process cycle of incremental rotation and exhaust fan operation. When the hopper is empty, the shredder is disengaged.

The shredder reduces the material into particles of approximately 3/32 to 3/16 inches in diameter, the maximum size calculated to facilitate efficient and complete composting in accordance with the process and apparatus of the invention. Smaller sized particles provide more edges to the material which result in an environment that is more suited to the bacteria. Smaller particles are also more easily dissolved when mixed into the existing active feed stock of the first chamber. Larger particle sizes begin to reduce the speed and effectiveness of the bacterial action in the first chamber.

Disengaging the operator switch turns off the shredder and the auger, and initiates a standard process cycle of drum rotation and exhaust fan operation, conducted by the controller and based on process conditions and predetermined or programmable times and process limits.

It has been found useful to add about one to three yards of a starter batch or resident compost to each of the first two chambers, to facility a quick initial startup of the process in a new install or restart situation. The specified input materials, for which the invention is intended, normally contain a sufficient amount of moisture, nitrogen and the required bacteria to maintain the composting process within the drum section as the working volumes in each chamber are accumulated and the excess is advanced to the next chamber. The process is exothermic and requires mainly only oxygen to be sustained to completion. The enclosure is well-insulated, so the primary requirement of the apparatus is to remove excess CO2, H20 (water vapor), and control the heat, and add sufficient makeup air to supply the oxygen needed in order to sustain the process.

The first chamber serves to mix the shredded materials into a homogenous mixture, stabilize the temperature and moisture content, and allow the composting process to engage the new material. It has a single, straight vane running lengthwise on the drum wall, parallel to the axis of rotation, which imparts tumbling action to the materials, but only once every complete rotation or once in three process cycles.

The second, largest chamber accepts the prepared material into a dedicated composting chamber, relatively isolated and insulated by the first and third chambers from exterior factors, where the bulk of the composting takes place, and likewise has a single mixing vane to assure tumbling of the materials. The third chamber is a smaller, final holding station that provides additional time for mixing, percolation of any reintroduced liquid, and final drying and cooling of the composted, final product to a uniform consistency, with a steady rate of outflow to the compost container. The third chamber has three, equally spaced mixing vanes to maximize tumbling of the materials at this stage.

The main purpose of the vanes in the first and second chambers is to promote and ensure tumbling within these drum sections, not for the forward progression of the material from one chamber to the next. As found in practice, any forward-inducing spiral or angle in these vanes will cause the composting material to progress through the drum too quickly, causing the material to traverse the three chambers and be discharged prior to fully completing the composting process.

Moisture is generally overabundant in the materials for which the apparatus is specified. Excessive moisture content in the materials, more than 60-65%, can inhibit the process and is reflected in reduced temperature in the working material. The liquid handling system is sized to handle the anticipated normal moisture content. However, supplement bulk material, mainly in the form of cardboard and other biodegradable packaging materials, is readily available to prospective users of the apparatus to absorb and balance the excessive moisture content of the primary materials if needed.

Assuming ambient outside air as a starting medium and makeup medium, increasing carbon dioxide levels in the drum will indicate consumption of oxygen. When the level of CO2 goes high, it can be assumed that there is not sufficient remaining oxygen to sustain the process at an efficient rate, and an air change is required. However, it should be noted that the specified input materials, and the operation of the apparatus as described here, can be expected to provide sufficient oxygen under all but extreme circumstances.

The controller is programmed to periodically execute a process cycle of limited drum rotation, a range of ½ to 1 turn being adequate, with ¾ turn being that of the preferred embodiment, which is calculated to be sufficient to roll and turn the materials in each chamber to expose a new layer to the available oxygen, and to advance any excess liquid towards the next downstream port. The stationary time, or period between automatic rotations, is calculated to permit the composting process to progress with the available oxygen, retaining most of the heat generated and outgassing at the rate of generated, at the back end of the apparatus. The period of repetition for the preferred embodiment is every three hours, but will likely be superseded by on-demand provisions for additional rotation and make-up air based on exceeding the high temperature limits or carbon dioxide levels in the drum.

The rotation cycle also includes concurrent operation of the exhaust fan with for air circulation in the drum. The flow rate of the fan and duration of operation as relates to the drum rotation, assures adequate air exchange and aeration consistent with the progress of the process. For the preferred embodiment, the fan on time is the same as incremental drum rotation time, typically less than a minute.

The preferred materials temperature, TM, operating range is between 150 and 169 degrees Fahrenheit. The materials temperature is being monitored through the wall of the drum whenever the drum is not rotating. Whenever the materials temperature TM is interpreted as exceeding 169 degrees Fahrenheit, beyond which the survival of beneficial bacteria is affected, a standard process cycle of ¾ turn drum rotation and exhaust fan operation are automatically commenced by the controller, after which the materials temperature is again reinitiated. More frequent drum rotation turns the material more often, causing a decrease in the materials temperature through greater convective and radiated heat transfer to the interior air, and the attendant air change produced by operation of the exhaust fan.

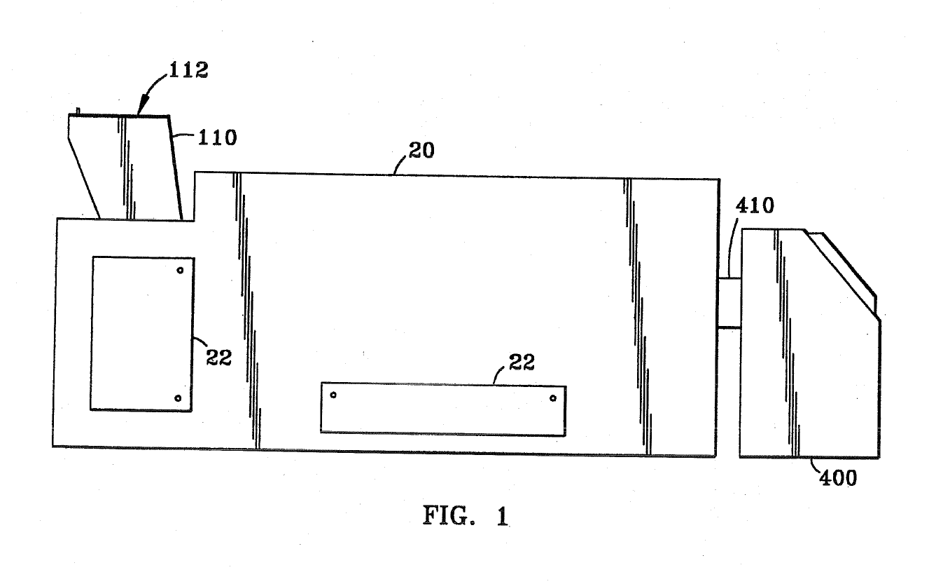

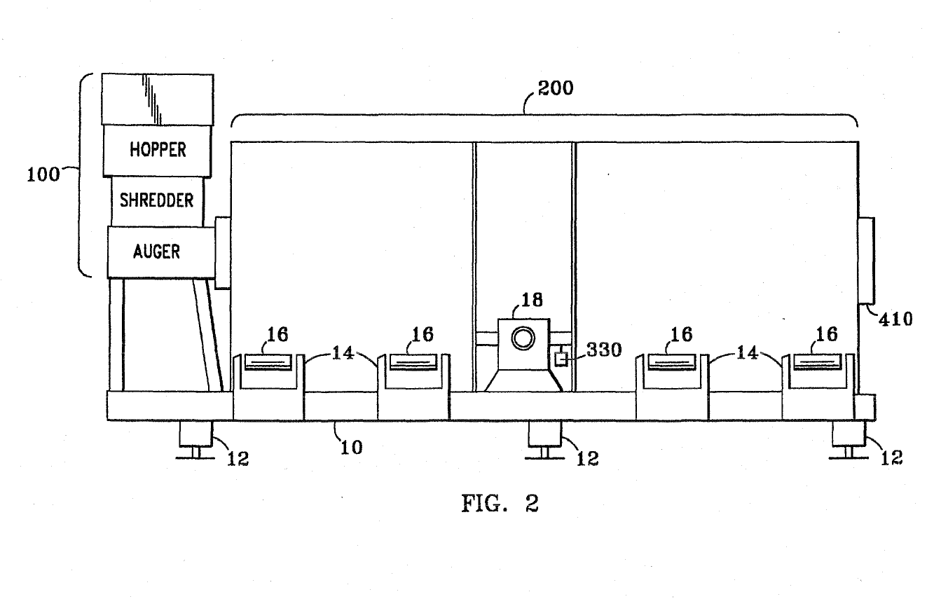

Referring now to FIGS. 1 and 2, specifically addressing the in-drum composting process, there is illustrated an in-feed section 100, drum section 200, process control system 300, and closed compost container 400. The in-feed section, drum section and process control system are mounted on base frame 10, which is leveled by adjustable legs 12, and suitably enclosed and insulated by enclosure 20 to operate as a unitary composting system. Access panels 22 provide access for maintenance purposes. The closed compost container 400 is closely coupled to the back end of drum section 200, while providing limited venting capability at the point of coupling 410. Enclosure 20 is substantially closed to drafts, but is not necessarily pressure proof, natural outgassing occurring by design in the venting noted at coupling 410 when the exhaust fan is not running.

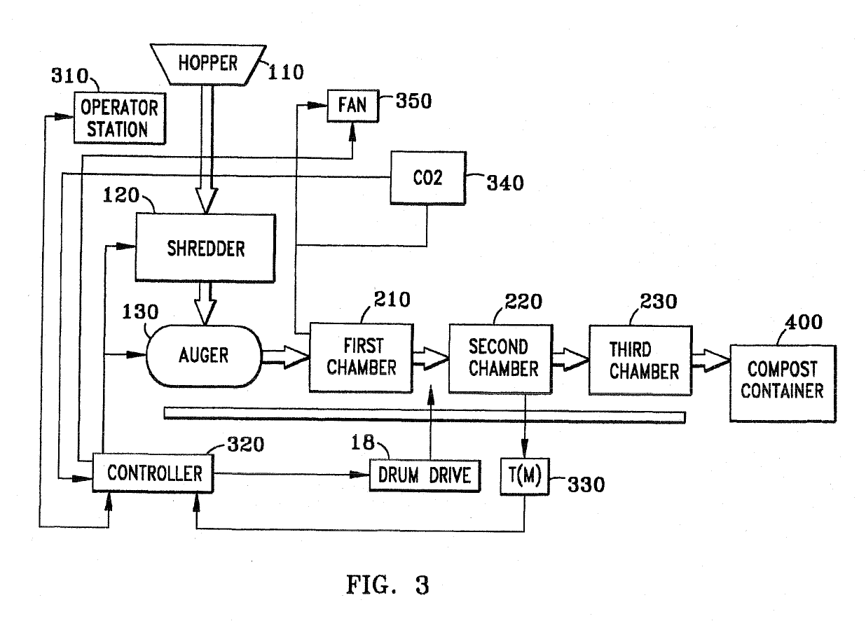

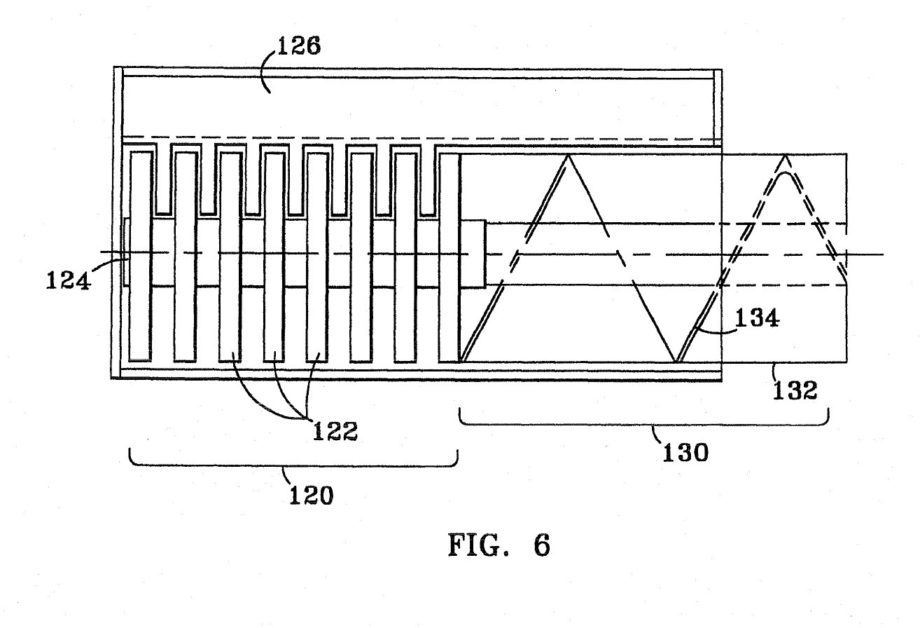

Referring to FIGS. 3, 5 and 6, in-feed section 100 has a feed hopper 110 about 40 inches by 20 inches and 30 inches deep, that is closed between feedings by hopper lid 112. The hopper feeds vertically downward into shredder 120. The shredder is a material shredder/particle sizer powered by an electric motor, comprising a series of spaced apart multi-toothed blades 122 on a rotating shaft 124 that rotate past a toothed striking plate 126, and operates at 30 to 90 RPM. The tooth size, blade size and spacing are calculated to tear and shred the supplied materials into particles 3/32 to 3/16 inches in diameter. The shredder is capable of handling the raw food waste, including bones, as well as supplemental bulk materials such as cardboard.

Shredder 120 feeds vertically downward into auger 130, which is horizontally oriented and likewise powered by an electric motor. The one by four foot chute 132 and vanes 134 of auger 130 deposit the shredded material into the drum section.

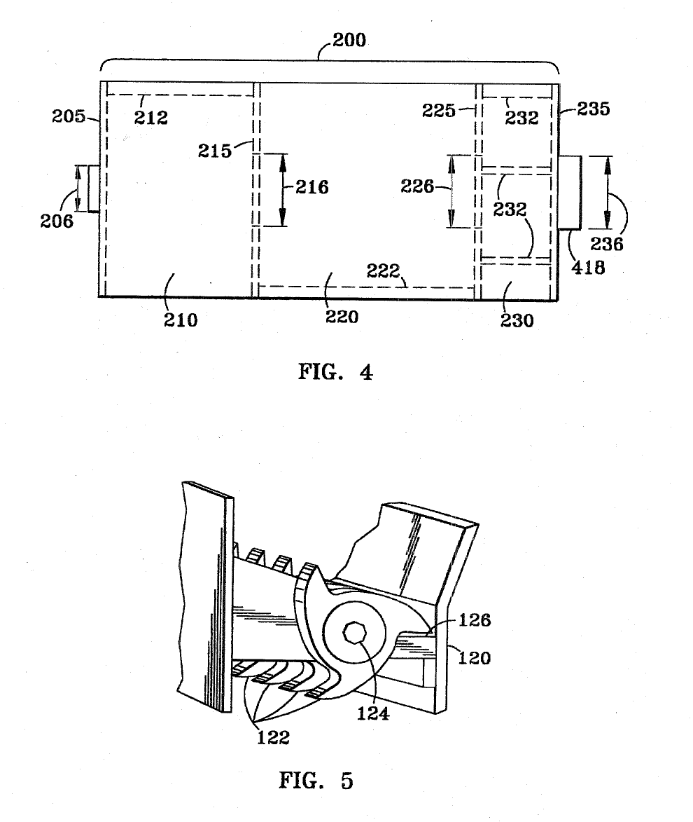

Referring to FIG. 4, drum section 200 comprising a 4800 gallon, 7.5 foot diameter, 30 foot long drum 201, which has a front end 205 and back end 235, with interior partitions 215 and 225 segregating the interior volume into three chambers, 210, 220, and 230 respectively. Chambers 210 and 220 each have single horizontal vanes 212 and 222 respectively, of about four inches height running the length of their respective chambers, attached perpendicular to the drum wall and to the end walls of the chambers. Chamber 230 has three, radially spaced vanes 232, similar to vanes 212 and 222.

In some embodiments, chambers 210 and 220 may also have three radially spaced vanes as in chamber 230. The vanes may further have spikes attached perpendicularly to the axial dimension of the vane to promote turning of the compost material and enhance aeration and mixture breakdown. The spikes may be spaced approximately two inches apart from one another and may be approximately 6 to 8 inches in length. The spikes may be fabricated from stainless steel.

The first chamber, 210, holds about 8 cubic yards of working volume of materials in process, retaining about 6 yards if input slows or ceases, and has a throughput cycle of about two to six days. The second chamber, 220, has a capacity of about 11 cubic yards, retaining about 8½ yards if input slows or ceases, and has a throughput cycle of about four to 10 days. The third chamber, 230, holds about 4¾ cubic yards, retaining about 3¾ yards if inflow slows or ceases. The external catch box, compost container 400, has a 5½ yard capacity.

Drum 201 is preferably fabricated of stainless steel; however it could be made of any other suitable material. Drum 201 is mounted horizontally on the base frame 10 so as to be rotatable on drum supports 14 and drum support rollers 16 by motorized drum drive system 18 comprising a motor and gearbox coupled to a dual chain assembly. Drive system 18 incorporates an automatic brake feature to prevent roll back of the drum after rotation, due to the displacement of the contents in the direction of rotation.

Interior partitions 215 and 225 of drum 201 are substantially planar, and perpendicular to the axis of the drum. Drum front end 205 has a relatively small axial port 206 of about 12 inches diameter, through which auger 130 deposits the shredded materials. Partitions 215 and 225 have relatively larger axial ports 216 and 226 of 14 and 16 inches diameter, respectively. Drum back end 235 has an axial port 236 of 18 inches diameter.

Referring to FIG. 3, the complete process path through the apparatus is into hopper 110, through shredder 120, via auger 130 through port 206 into chamber 210, and successively through chambers 220, 230, as moved by drum rotation and the gradual down slope flow through successively larger ports, through port 236 into compost container 400, from which the finished compost is periodically removed.

Again referring to FIG. 3, process control system 300 comprising an operator's station 310, process controller 320 and process sensors including temperature sensor 330, an optional CO2 or Oxygen sensor 340, and a biofilter equipped exhaust fan 350. The controller also receives inputs from an operator switch at operator's station 310, and various safety switches on the apparatus. The controller output controls shredder 120, auger 130, drum drive system 18, and exhaust fan 350. The duct for exhaust 350 is connected at the front end of the system so as to exhaust interior air and draw makeup air in from the vents at coupling 410 at the back end of the apparatus. Operator's station 310 is provided with temperature level readout and optional carbon dioxide level readout.

Temperature sensor 330 is located at the base of the drum in the area of the center chamber. The sensor assembly alternately bears on the exterior wall of center chamber 220 when the drum is not rotating, and is lifted clear by a cam when the drum is rotating. Sensor 330 contacts the drum at any point rotationally forward of bottom dead center where the center of mass of contained material is concentrated by the rotating action of the drum.

An alternative temperature sensing arrangement is provided by installing sensors in the second chamber at indexed stopping points where one will always be embedded in the material in process when the rotation stops. A connection is made through the drum wall between the sensor and an external, coincident pickup point, connecting to the controller.

Electrical power is supplied for compressor, transfer pumps, and supplemental heat, in addition to drum rotating and fans. Corresponding control circuit components including liquid level sensors such as float switches and temperature sensors are provided. The entire system is insulated and enclosed to maintain temperature stability.

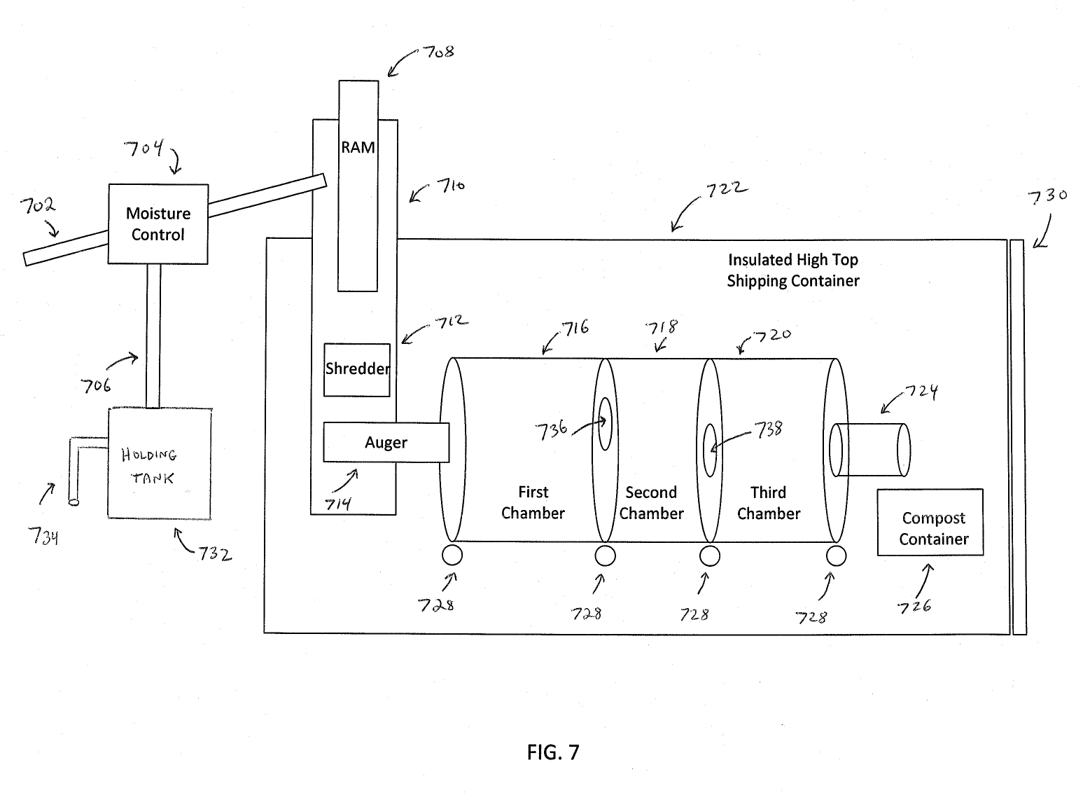

Referring now to FIG. 7, which shows a diagrammatic side elevation of another embodiment of the invention, incoming material, or feedstock, is fed into the system on a conveyor belt 702 which passes through a moisture control unit 704. The moisture control unit 704, squeezes excess moisture out of the incoming material through a system of rollers or other suitable means to compress the material. This excess liquid is drained through pipe 706 into holding tank 732 where it is stored for further use or disposal by an elevated opening in the tank that directs any overflow liquid into a drain system by pipe 734.

The compressed feedstock continues on conveyer belt 702 to an input port or tunnel 710 where it passes into the shredder 712 which properly sizes the product to a diameter of approximately 3/32 to 3/16 inches. Once the proper size of the organic matter is obtained, an auger 714 transfers the newly sized feedstock into the first chamber 716, which is about ¾ full of composting organic matter, and blended.

Hydraulic ram 708 is provided to clear the input port 710 in the event of jams or backup of the feedstock. The ram 708 may be activated by sensors in the port 710 or the shredder 712 that are capable of detecting a jam condition.

The first chamber 716 is the first step in the process which blends incoming product with older, already composting matter. Organic matter in its natural state is composed of nitrogen and carbon. The ratio of carbon to nitrogen can range between 17 to 1 and 20 to 1. Prior evaluation of the feed stock may be necessary to determine if additives are needed to assist in the composting process. When the carbon and nitrogen values are balanced in the range of 20:1 the process of decomposition will proceed rapidly as the biological process increases its activity to maximum thermophilic temperature ranges.

The temperatures and biological activity continue to break down the organic matter when the oxygen and moisture levels are within a balanced range. This is accomplished by removing excess moisture through the moisture control unit 704, which squeezes the in-feed product to reduce water levels, and by turning the vessel which creates a blending of oxygen in the atmosphere of the vessel.

When the first chamber 716 reaches a predetermined level, as set by an offset port 736 which allows the first chamber to have a greater depth of the now composting feedstock, the product is transferred into the second chamber 718 where the process continues to accelerate the decomposition of the matter.

The second chamber 718 is insulated from outside sources by its location while sensors monitor the oxygen and moisture levels to ensure rapid decomposting of the organic matter. When the second chamber 718 reaches a predetermined level it is transferred into the third chamber 720.

The third chamber 720 continues the process and at this point the product no longer contains any items that would be recognizable from the input material such as food stuffs. The excess liquid that was removed at the in feed conveyor may be reintroduced into the third chamber as needed depending on moisture levels determined by sensors. The goal is to keep the moisture levels under 50% but greater than 20%. When the third chamber reaches its proper level the now decomposed organic matter is transferred through an exit port 724 into a container 726 where it is made available for removal from the composter. The finished compost can be used as a fertilizer and a suppressor of disease and can be applied directly to vegetation or augmented into soil.

As illustrated in FIG. 7, most of the apparatus may be contained within an insulated high top shipping container 722. An automatic door 730 may also be deployed to permit access into the container 722 for the removal of the compost container 726 when it is filled with finished product. Rollers 728 on front and back sides of the containment vessel prevent it from moving laterally as it rotates.

A computer system, not shown, may be located in a suitable position to monitor all phases of the process through a variety of sensors. Sensors may include those for moisture, pH, temperature, oxygen, carbon dioxide and nitrogen. There may also be sensors to monitor system capacity, jamming and the need for maintenance. The computer system is capable of communication with an operator to maintain proper functioning of the composting system.

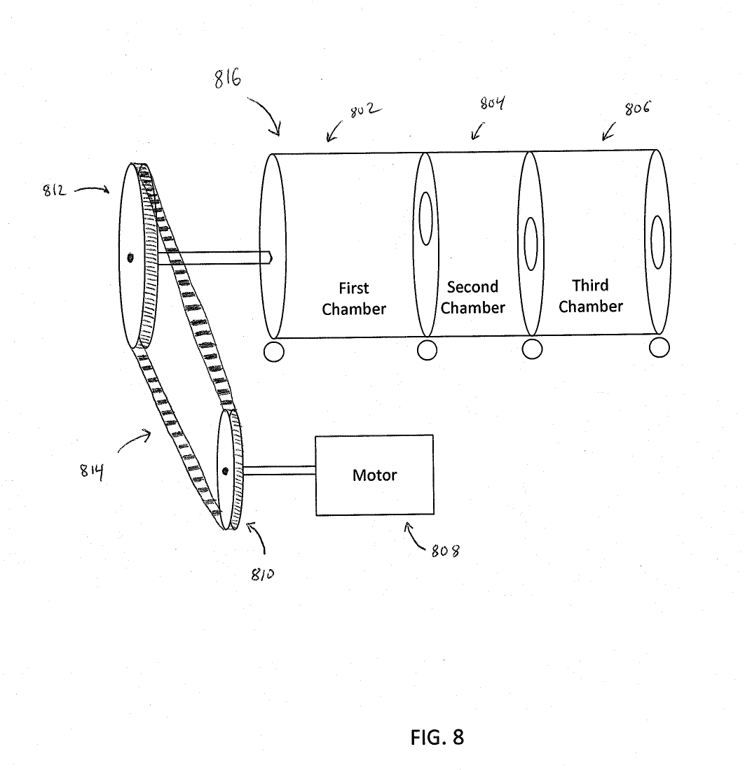

Referring now to FIG. 8, a diagrammatic side elevation of another embodiment of the invention illustrating the drive mechanism is shown. Motor 808, which may be an electric motor, is engaged to sprocket 810 which drives bull wheel 812 through a chain or belt 814. Bull wheel 812 is engaged to containment vessel 816, containing chambers 802, 804 and 806, which results in the rotation of containment vessel 816 as motor 808 turns.

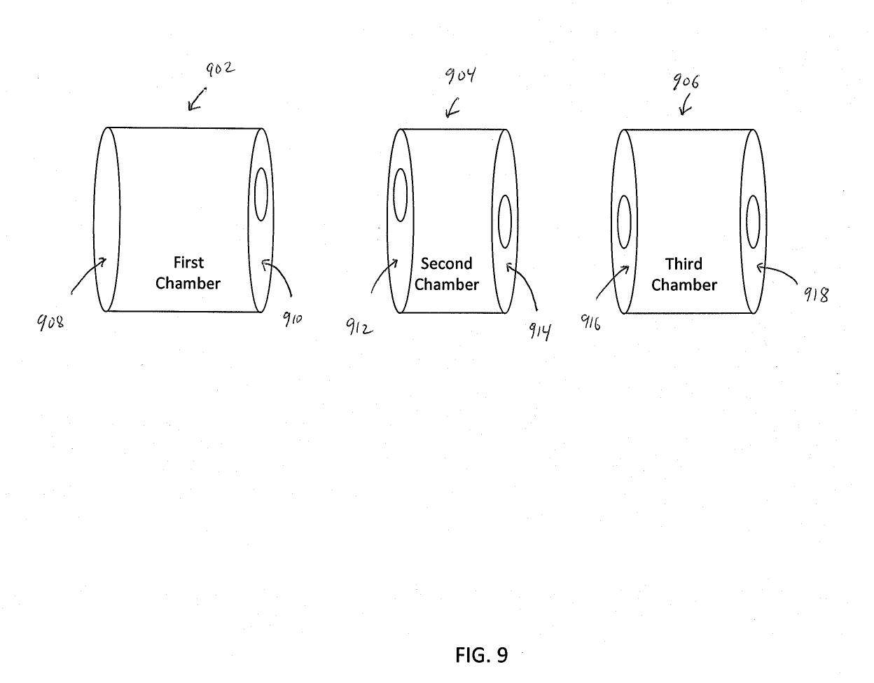

Referring now to FIG. 9, a diagrammatic side elevation of another embodiment of the invention is shown which illustrates the construction of the separate chambers. Composting vessel 816, of FIG. 8, may be constructed out of individual chambers 902, 904 and 906. Each of the individual chambers 902, 904 and 906 has its own side walls 908 and 910, 912 and 914, and 916 and 918. The four interior edge pairs 910, 912 and 914, 916 can be manufactured so that each element of the pair is identical to the mating element of the pair. The resulting assembly will strengthen the overall containment vessel at the points where the rollers carry the weight of the vessel. The additional strength will also provide increased rigidity and diminish any sagging effects along the length of the vessel.

In some embodiments, sacrificial pieces of metal, such as aluminum, are located within the containment vessel near access ports to mitigate the effects of corrosion on the container.

It should be noted that the materials and individual components from which the various embodiments are constructed are not of themselves novel or unusual, and so are not illustrated in detail. This in no way detracts from a clear understanding of the invention for practitioners skilled in the art.

As will be realized, the invention is capable of other and different embodiments, and its several details are capable of modifications in various obvious respects, all without departing from the essence of the invention. For instance, the invention may be practiced as an apparatus and/or process, and can be scaled, so long as the critical parameters of the process are satisfied. A small version of the embodiment would be practical for a home owner, an intermediate version is practical for use by a restaurant or supermarket, and a large version would be practical for a municipal collection/drop-off facility.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. An in-vessel composting apparatus for continuous processing of food waste into bulk composting material, comprising:
a first, second and final cylindrical chamber attached one to the next along the cylindrical axis to form a rotatable horizontal drum, wherein each of said chambers has an axial input port and an axial output port on opposing faces of the cylinder and which align from one said chamber to the next;
a conveyor belt to feed said food waste into a moisture control unit, wherein said moisture control unit compresses excess moisture from said food waste for storage in a holding tank;
an input chute to receive said food waste from said conveyor belt after passing through said moisture control unit;
a shredder to reduce said food waste passed through said input chute into smaller particles having diameters in the range of 3/32 inch to 3/16 inch;
an auger to convey said food waste from said shredder into said horizontal drum;
a sensor to detect a jam condition in said input chute;
a ram to clear said jam condition from said input chute in response to said detected jam condition; and
a motor to rotate said horizontal drum.

2. The in-vessel composting apparatus of claim 1, further comprising an insulated shipping container to enclose said horizontal drum.

3. The in-vessel composting apparatus of claim 1, wherein said moisture control unit comprises a plurality of rollers through which said food waste passes, said rollers compressing said excess moisture from said food waste.

4. The in-vessel composting apparatus of claim 1, further comprising a mechanism to reintroduce a portion of said excess moisture from said holding tank into said final chamber to maintain moisture content of final product at a desirable level.

5. The in-vessel composting apparatus of claim 4, further comprising a compost container to receive said final product from said final chamber.

6. The in-vessel composting apparatus of claim 5, wherein said insulated shipping container further comprises an automatic door to provide access to said compost container.

7. The in-vessel composting apparatus of claim 1, further comprising:
a plurality of sensors to monitor conditions throughout said composting apparatus;
a computer to control rotation of said horizontal drum based on said monitored conditions and to provide status to an operator.

8. The in-vessel composting apparatus of claim 7, wherein said sensors comprise at least one of:
a moisture sensor;
a pH sensor;
a temperature sensor;
an oxygen sensor;
a carbon dioxide sensor;
a nitrogen sensor;
a system capacity sensor;
a jamming sensor; and
a maintenance sensor.

9. A continuous process for in-vessel composting of food waste into bulk composting material, comprising the steps of:
compressing excess moisture from said food waste;
storing said excess moisture;
shredding said food waste into particles having a diameter in the approximate range of 3/32 to 3/16 inches;
inserting said food waste into a first chamber of a rotatable drum comprising at least three chambers serially connected by axial ports and having means for gradual advancement of said food waste through said chambers while composting, such that a bulk composting material is deposited in the final chamber of said three chambers; and
introducing a portion of said stored excess moisture into the final chamber of said chambers.

10. A continuous process for in-vessel composting according to claim 9, further comprising the steps of:
permitting low pressure outgassing from said drum;
measuring temperature in said second chamber;
incrementally rotating said drum about its axis; and
periodically exchanging air in said drum for outside air.

11. A continuous process for in-vessel composting according to claim 10, further comprising the conducting of said process within an insulated shipping container.

12. A continuous process for in-vessel composting according to claim 11, further comprising the step of using a computer controller for integrating and automating the several said steps.

13. An in-vessel composting apparatus for continuous processing of food waste into bulk composting material, comprising:
a rotatable horizontal drum with an input end having an axial input port and an output end having an axial discharge port, said drum divided in length by interior partitions into at least first, second and final chambers, each said partition having an axial port by which adjacent said chambers are connected;
means for conveying said food waste into the apparatus;
means for compressing excess moisture from said food waste;
means for storing some portion of said excess moisture;
means for shredding and inserting said food waste into said first chamber;
means for sensing a jam condition at input to shredder;
means for clearing said jam condition;
means for passing remaining said food waste in incremental amounts from said first chamber to said second chamber and from said second chamber as bulk composting material into said final chamber;
means for permitting low pressure outgassing from said drum;
means for measuring temperature in said second chamber;
means for incrementally rotating said drum about its axis;
means for exchanging air in said drum for outside air; and
means for reintroducing said stored excess moisture into said final chamber.

14. An in-vessel composting apparatus according to claim 13, further comprising an operator station and a controller, said controller communicating with at least: said means for shredding and inserting, said means for incrementally rotating said drum, said means for measuring temperature, said means for exchanging air, and said operator station.

15. An in-vessel composting apparatus according to claim 14, said means for shredding and inserting comprising an input hopper connecting to a multi-toothed rotary shredding mechanism connecting to an auger and chute assembly connecting to said axial input port of said input end of said drum.

16. An in-vessel composting apparatus according to claim 15, said axial ports being of sequentially larger diameter from said input port to said discharge port.

17. An in-vessel composting apparatus according to claim 16, said chambers further comprising interior structure for tumbling contents during rotation, said structure oriented parallel to said axis of said drum.

18. An in-vessel composting apparatus according to claim 17, said means for incrementally rotating said drum comprising a base frame with drum supports and drum support rollers upon which said drum rests, and a motorized drum drive system comprising a motor and gearbox attached to said base frame and coupled to said drum by at least one endless belt.

19. An in-vessel composting apparatus according to claim 16, further comprising an insulated shipping container to enclose said apparatus.

20. An in-vessel composting apparatus according to claim 19, said means for exchanging air in said drum for outside air comprising an exhaust fan and duct, said duct connecting to said drum in the vicinity of said input end.
